(19) United States
(12) Patent Application Publication
(10) Pub. No.: US 2014/0285714 A1
(43) Pub. Date: Sep. 25, 2014

(54) PORTABLE ELECTRONIC DEVICE AND DISPLAY METHOD

(71) Applicants: HON HAI PRECISION INDUSTRY CO., LTD., New Taipei (TW); HONG FU JIN PRECISION INDUSTRY (WuHan) CO., LTD., Wuhan (CN)

(72) Inventors: MIN YANG, Wuhan (CN); JIAN-HUNG HUNG, New Taipei (TW)

(73) Assignees: HON HAI PRECISION INDUSTRY CO., LTD., New Taipei (TW); HONG FU JIN PRECISION INDUSTRY (WuHan) CO., LTD., Wuhan (CN)

(21) Appl. No.: 14/067,925

(22) Filed: Oct. 30, 2013

(30) Foreign Application Priority Data
Mar. 25, 2013 (CN) 2013100957314

(51) Int. Cl. H04N 7/10; H04N 7/01

(52) U.S. Cl. CPC H04N 7/104; H04N 7/0102
USPC 348/441

(57) ABSTRACT

A portable electronic device includes an earphone jack, a display, a video card, a switch, a conversion module, and a transmission module. The video card converts digital video signals into analog video signals and sends the analog video signals to the display. The switch generates a double-screen display signal in response to a user's operation thereon. The conversion module converts the digital video signals into analog audio signals in real time according to the double-screen display signal. The transmission module transmits the converted analog audio signals to another portable electronic device through a signal wire. Two ends of the signal wire plug into two earphone jacks of the two portable electronic devices, respectively. A display method is also provided.

### BACKGROUND

1. Technical Field

The present disclosure relates to a portable electronic device and a display method.

2. Description of the Related Art

Display screens of portable electronic devices are small. Thus, videos displayed on the display screen are inconvenient to be watched for a number of people.

### BRIEF DESCRIPTION OF THE DRAWING

The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a schematic view of a display system.

FIG. 2 is a block diagram of the display system in FIG. 1.

FIG. 3 is a flowchart of a display method.

### DETAILED DESCRIPTION

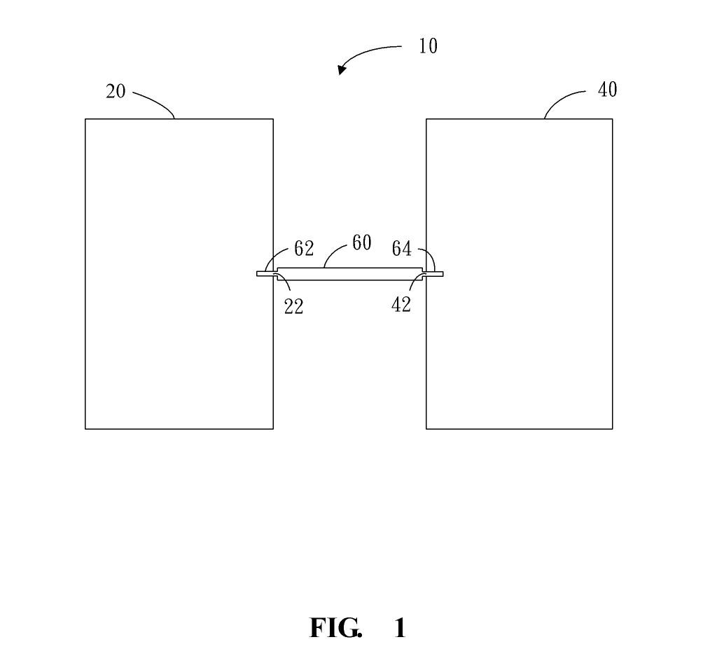

FIG. 1 shows a schematic view of a display system 10. The display system 10 includes a first portable electronic device 20, a second portable electronic device 40, and a signal wire 60. The first portable electronic device 20 includes a first earphone jack 22. The second portable electronic device 40 includes a second earphone jack 42. The signal wire 60 includes two earphone plugs 62, 64 at opposite ends of the signal wire 60, respectively. The two earphone plugs 62, 64 are configured to plug into the first earphone jack 22 and the second earphone jack 42, respectively, to connect the first portable electronic device 20 to the second portable electronic device 40.

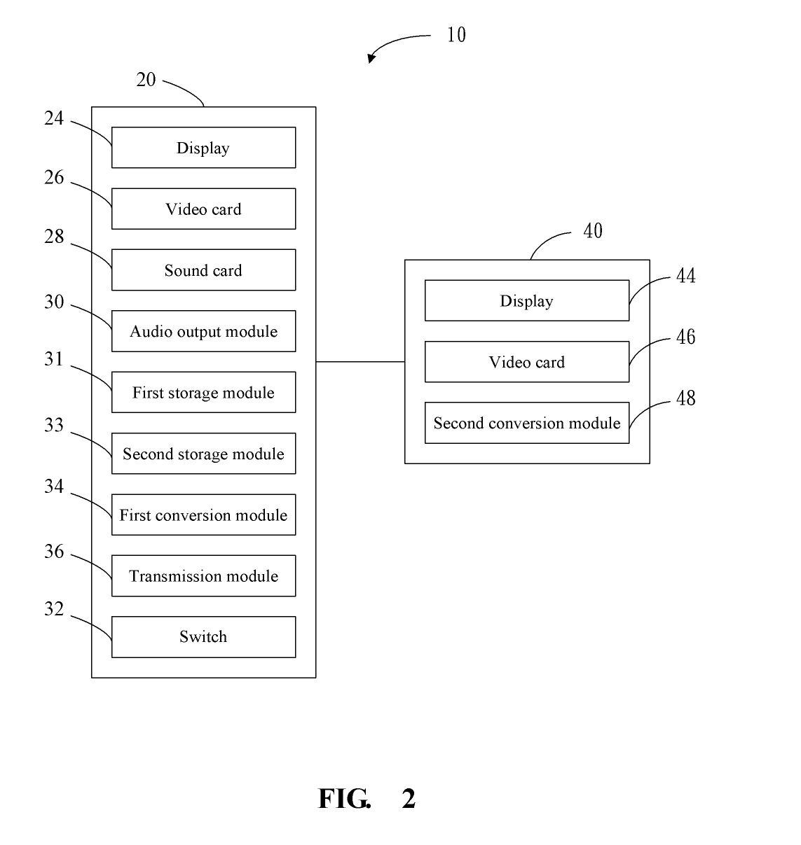

FIG. 2 shows a block diagram of the display system 10. The first portable electronic device 20 includes a display 24, a video card 26, a sound card 28, an audio output module 30, a switch 32, a first storage module 31, a second storage module 33, a first conversion module 34, and a transmission module 36.

The first storage module 31 is configured to store digital video signals of the first portable electronic device 20. The second storage module 33 is configured to store digital audio signals corresponding to the digital video signals.

The video card 26 is configured to convert the digital video signals into analog video signals and transmit the analog video signals to the display 24 to display the analog video signals. The sound card 28 is configured to convert the digital audio signals into analog audio signals and transmit the analog audio signals to the audio output module 30. The audio output module 30 is configured to output the analog audio signals. In this embodiment, the audio output module 30 is a loudspeaker.

The switch 32 is configured to generate a double-screen display signal in response to a user's operation on the switch 32. The first conversion module 34 is configured to convert the digital video signals into analog audio signals in real time according to the double-screen display signal. In this embodiment, the first conversion module 34 is a modem.

The transmission module 36 is configured to transmit the converted analog audio signals to the second portable electronic device 40 through the signal wire 60.

The second portable electronic device 40 includes a display 44, a video card 46, and a second conversion module 48. The second conversion module 48 is configured to convert the converted analog audio signals transmitted through the signal wire 60 into digital video signals. In this embodiment, the second conversion module 48 is a modem. The video card 46 is configured to convert the digital video signals into analog video signals and transmit the analog video signals to the display 44 to display the analog video signals.

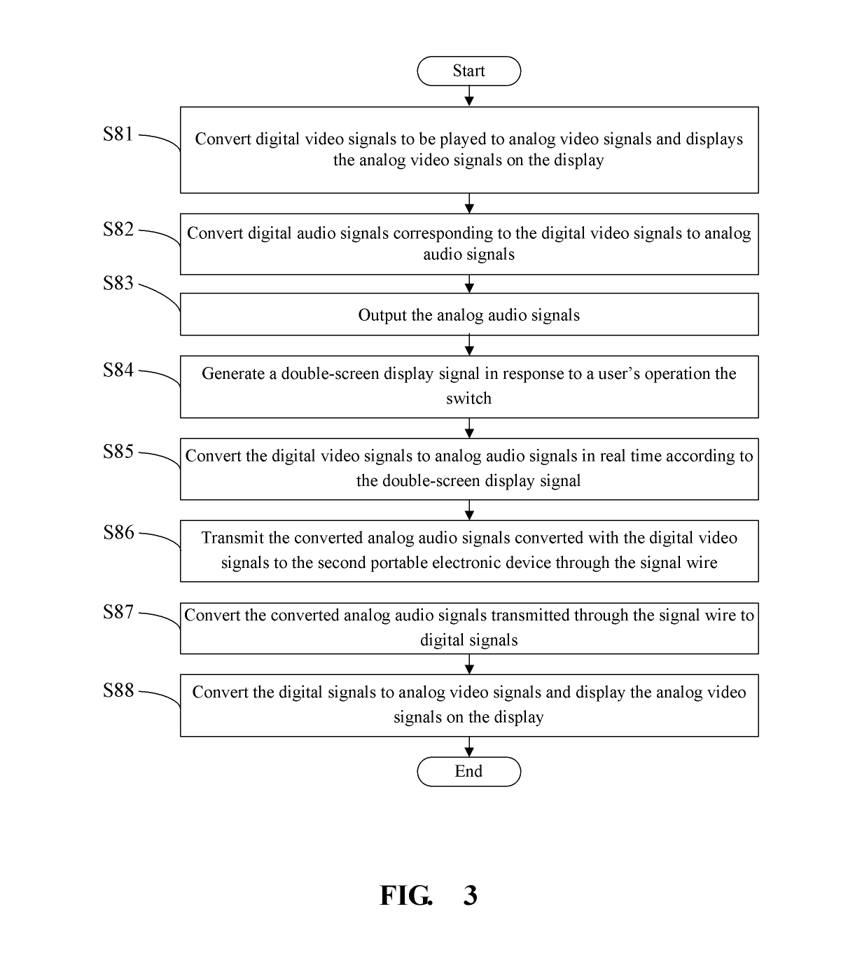

FIG. 3 shows a flowchart of a display method.

In step S81, the video card 26 converts digital video signals of the first portable electronic device 20 into analog video signals and sends the analog video signals to the display 24 to display the analog video signals.

In step S82, the sound card 28 converts digital audio signals corresponding to the digital video signals into analog audio signals and transmits the analog audio signals to the audio output module 30.

In step S83, the audio output module 30 outputs the analog audio signals. The audio output module 30 is a loudspeaker.

In step S84, the switch 32 generates a double-screen display signal in response to a user's operation on the switch 32.

In step S85, the first conversion module 34 converts the digital video signals into analog audio signals in real time according to the double-screen display signal.

In step S86, the transmission module 36 transmits the converted analog audio signals to the second conversion module 48 of the second portable electronic device 40 through the signal wire 60.

In step S87, the second conversion module 48 converts the converted analog audio signals into digital video signals.

In step S88, the video card 46 converts the digital video signals into analog video signals and transmits the analog video signals to the display 44.

Videos displayed on the display 24 of the first portable electronic device 20 also are displayed on the display 44 of the second portable electronic device 40 through the display system 10. Thus, users can watch videos on the display 24 and the display 44 simultaneously.

It is understood that the present disclosure may be embodied in other forms without departing from the spirit thereof. Thus, the present examples and embodiments are to be considered in all respects as illustrative and not restrictive, and the disclosure is not to be limited to the details given herein.

What is claimed is:

1. A portable electronic device comprising:
an earphone jack configured to receive one earphone plug of a signal wire comprising two earphone plugs at two ends of the signal wire;
a first storage module configured to store digital video signals to be played;
a display;
a video card configured to convert the digital video signals into analog video signals and display the analog video signals on the display;
a switch configured to generate a double-screen display signal in response to a user's operation thereon;
a conversion module configured to convert the digital video signals into analog audio signals in real time according to the double-screen display signal; and
a transmission module configured to transmit the converted analog audio signals to another portable electronic device comprising an earphone jack through the signal wire with the earphone plugs thereof respectively plugged in the earphone jack of the portable electronic device and the earphone jack of the another portable electronic device.

2. The portable electronic device as claimed in claim 1, further comprising a second storage module, a sound card and an audio output module, the second storage module configured to store digital audio signals corresponding to the digital video signals, the sound card configured to convert the digital audio signals into analog audio signals and transmit the analog audio signals to the audio output module, the audio output module configured to output the analog audio signals.

3. The portable electronic device as claimed in claim 2, wherein the audio output module is a loudspeaker.

4. The portable electronic device as claimed in claim 1, wherein the conversion module is a modem.

5. A portable electronic device comprising:
an earphone jack configured to receive one earphone plug of a signal wire comprising two earphone plugs at opposite ends of the signal wire;
a conversion module configured to convert analog audio signals transmitted from another portable electronic device comprising an earphone jack through the signal wire with the earphone plugs thereof respectively plugged in earphone jacks of the portable electronic device and the another portable electronic device into digital signals; and
a video card configured to convert the digital signals into analog video signals and display the analog video signals on the display.

6. The portable electronic device as claimed in claim 5, wherein the conversion module is a modem.

7. A display method comprising:
converting digital video signals to be played stored in a first portable electronic device into analog video signals and displaying the analog video signals on a display of the first portable electronic device;
generating a double-screen display signal in response to a user's operation on the first portable electronic device;
converting the digital video signals into analog audio signals in real time according to the double-screen display signal;
transmitting the converted analog audio signals to a second portable electronic device through a signal wire which comprises two earphone plugs at opposite ends of the signal wire and the two earphone plugs respectively plugged in an earphone jack of the first portal electronic device and an earphone jack of the second portal electronic device;
converting the converted analog audio signals transmitted through the signal wire into digital signals; and
converting the digital signals into analog video signals and display the analog video signals on a display of the second portable electronic device.

8. The display method as claimed in claim 7, further comprising:
converting digital audio signals corresponding to the digital video signals and stored in the first portable electronic device into analog audio signals; and
outputting the analog audio signals.
